(19) United States
(12) Patent Application Publication
(10) Pub. No.: US 2025/0244492 A1
(43) Pub. Date: Jul. 31, 2025

(54) QUICK DEPTH VELOCITY MODEL FOR A LARGE AREA BASED ON DEEP LEARNING

(71) Applicant: SAUDI ARABIAN OIL COMPANY, Dhahran (SA)

(72) Inventors: Ewenet Gashawbeza, Dhahran (SA); Jianwu Jiao, Dhahran (SA)

(73) Assignee: SAUDI ARABIAN OIL COMPANY, Dhahran (SA)

(21) Appl. No.: 18/424,432

(22) Filed: Jan. 26, 2024

(51) Int. Cl. G01V 1/28; G01V 1/30; G01V 1/50

(52) U.S. Cl. CPC G01V 1/282; G01V 1/303; G01V 1/50; G01V 2210/6222; G01V 2210/65

(57) ABSTRACT

A method for determining a depth velocity model for a seismic survey, that includes obtaining a seismic dataset in a region of interest, obtaining training common depth point (CDP) gathers in a training region within the region of interest, and obtaining a training depth velocity model in the training region. The method further includes constructing a training dataset from the training CDP gathers and the training depth velocity model, and training an artificial intelligence (AI) model to receive a CDP gather and output a velocity trace at the location of the CDP gather. The method further includes obtaining, from the seismic dataset, production CDP gathers in a production region and determining, with the AI model, production velocity traces in the production region. The method further includes determining an extended depth velocity model over the region of interest based on the set of production velocity traces.

### BACKGROUND

Velocity model building constitutes a resource intensive step in seismic processing projects. Generally, obtaining velocity fields from seismic data relies on approximative assumptions and computationally expensive methods that often require many iterations, such as residual moveout tomography and full waveform inversion techniques.

Recently, machine learning models have been developed to automatize the velocity model building process in an area of interest. These machine learning models rely on training data that include seismic data as input and depth velocity models as outputs. However, such training data is often unavailable or sparse.

Due to the sparsity and proprietary aspect of available seismic data, training datasets are usually small. Moreover, the geographical areas of the training data often have a very different geology compared to the geology of the area of interest. This may result in underperforming machine learning models when used as predictors in the area of interest.

Accordingly, there is a need for machine learning models that automatize the velocity model building process of a seismic project, using training data from the same project.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for determining a depth velocity model for a seismic survey. The method includes obtaining a seismic dataset of seismic traces, each seismic trace having a location, the locations of the seismic traces discretizing a region of interest, and obtaining a plurality of training common depth point (CDP) gathers of seismic traces, each training CDP gather having a location, the locations of the plurality of training CDP gathers discretizing a training region, where the training region is included in the region of interest. The method further includes obtaining a training depth velocity model of training velocity traces, each training velocity trace having a location within the training region, and constructing a training dataset of training examples, where each training example includes a training CDP gather of the plurality of training CDP gathers, and a training velocity trace of the training depth velocity model having a same location as the training CDP gather. The method further includes training, using the training dataset, an artificial intelligence (AI) model configured to receive a CDP gather as input and return, as output, a velocity trace at the location of the CDP gather. The method further includes obtaining production CDP gathers from the seismic dataset, each production CDP gather having a location, the locations of the production CDP gathers discretizing a production region. The method further includes determining, with the AI model, a set of production velocity traces, based on the production CDP gathers, each production velocity trace having a location, the locations of the production velocity traces discretizing the production region. The method further includes determining an extended depth velocity model of extended velocity traces based on, at least, the set of production velocity traces, the locations of the extended velocity traces discretizing the region of interest.

Embodiments disclosed herein generally relate to a system for determining a depth velocity model for a seismic survey. The system includes a seismic acquisition system configured to acquire a seismic dataset of seismic traces, each seismic trace having a location, the locations of the seismic traces discretizing a region of interest. The system further includes a seismic processing system, configured to receive the seismic dataset from the seismic acquisition system and form using the seismic dataset, or receive, a plurality of training common depth point (CDP) gathers of seismic traces, each training CDP gather having a location, the locations of the plurality of training CDP gathers discretizing a training region, where the training region is included in the region of interest. The seismic processing system is further configured to receive or compute a training depth velocity model of training velocity traces, each training velocity trace having a location within the training region, and construct a training dataset of training examples, where each training example includes a training CDP gather of the plurality of training CDP gathers, and a training velocity trace of the training depth velocity model having a same location as the training CDP gather. The seismic processing system is further configured to train, using the training dataset, an artificial intelligence (AI) model configured to receive a CDP gather as input and return, as output, a velocity trace at the location of the CDP gather. The seismic processing system is further configured to form production CDP gathers from the seismic dataset, each production CDP gather having a location, the locations of the production CDP gathers discretizing a production region. The seismic processing system is further configured to determine, by using the AI model with each production CDP gather as input, a set of production velocity traces, based on the production CDP gathers, each production velocity trace having a location, the locations of the production velocity traces discretizing the production region. The seismic processing system is further configured to determine an extended depth velocity model of extended velocity traces based on, at least, the set of production velocity traces, the locations of the extended velocity traces discretizing the region of interest.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic acquisition survey, in accordance with one or more embodiments disclosed herein.

FIG. 2 depicts a system for producing an extended depth velocity model for a subsurface, in accordance with one or more embodiments disclosed herein.

FIG. 3 is a block diagram for system for finding a potential hydrocarbon reservoir and drilling a well perforating it, in accordance with one or more embodiments disclosed herein.

FIG. 4 depicts an example diagram of a neural network, in accordance with one or more embodiments disclosed herein.

FIG. 5 depicts a well drilling site, in accordance with one or more embodiments disclosed herein

FIG. 6 is a flowchart a method for determining an extended depth velocity model using artificial intelligence, a in accordance with one or more embodiments disclosed herein.

FIG. 7 depicts an example diagram of a computer, in accordance with one or more embodiments disclosed herein.

FIG. 8A depicts an example of a region of interest, a training region and a production region, in accordance with one or more embodiments disclosed herein.

FIG. 8B depicts an example of a region of interest, a training region and a production region, in accordance with one or more embodiments disclosed herein.

FIG. 8C depicts an example of a region of interest, a training region and a production region, in accordance with one or more embodiments disclosed herein.

FIG. 9 depicts a synthetic example of a depth sonic log and a velocity profile, in accordance with one or more embodiments disclosed herein.

FIG. 10 depicts a synthetic example of a well-tie analysis, in accordance with one or more embodiments disclosed herein.

FIG. 11 depicts an example depth sampling, in accordance with one or more embodiments disclosed herein.

FIG. 12 depicts two example depth samplings, in accordance with one or more embodiments disclosed herein.

FIG. 13 depicts an example of a velocity model and an extended depth velocity model, a in accordance with one or more embodiments disclosed herein.

FIG. 14 depicts an example depth image, in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a computer may reference two or more such computers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

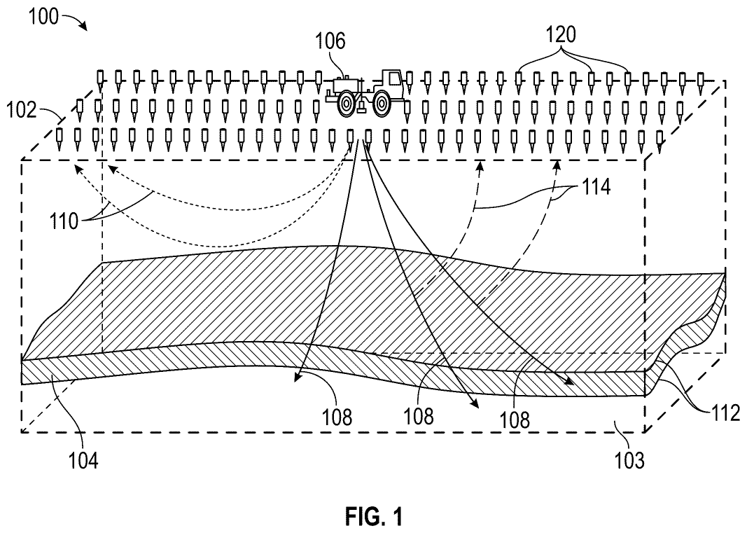

In the following description of FIGS. 1-14, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

The term “seismic dataset” as used herein broadly means any dataset received and/or recorded as part of the seismic surveying process, including particle displacement, velocity and/or acceleration, pressure and/or rotation, wave reflection, and/or refraction data. Thus, “seismic dataset” can include image data (e.g., seismic image, migration image, reverse-time migration image, pre-stack image, partially-stack image, full-stack image, post-stack image or seismic attribute image) and properties. Properties can include geophysical properties such as one or more of: elastic properties (e.g., P and/or S wave velocity, P-Impedance, S-Impedance, density, attenuation, anisotropy and the like); porosity; and permeability or the like. One with ordinary skill in the art will recognize that, in general, a seismic dataset may be inferred or otherwise derived from data received and/or recorded as part of a seismic surveying process. Thus, this disclosure may at times refer to a “seismic dataset and/or dataset derived therefrom,” or equivalently simply to a “seismic dataset”. Both terms are intended to include both a measured/recorded seismic dataset and such a derived dataset, unless the context clearly indicates that only one or the other is intended. A properly processed seismic dataset may aid in decisions as to if and where to drill for hydrocarbons. A seismic trace may be a time series, with samples at monotonically increasing times, or after some processing, a depth series with samples at monotonically increasing depths.

The terms “velocity model,” “density model,” “physical property model,” or other similar terms as used herein refer to a numerical representation of parameters for subsurface regions. Generally, the numerical representation includes an array of numbers, typically a 2-D or 3-D array, where each number, which may be called a “model parameter,” is a value of velocity, density, or another physical property in a cell, where a subsurface region has been conceptually divided into discrete cells for computational purposes (i.e., discretized). For example, the spatial distribution of velocity may be modeled using constant-velocity units (layers) through which its ray paths, obeying or modeled according to Snell's law, can be traced.

A depth velocity model represents the seismic velocity or the speed that a seismic wave propagates through a subsurface material. Different subsurface materials may exhibit different seismic velocities. A depth velocity model may be determined from a seismic dataset using a variety of methods, known to a person of ordinary skill in the art, collectively called “velocity analysis.” A geological model is a spatial representation of a distribution of sediments and rocks (rock types) in the subsurface.

FIG. 1 shows a seismic survey (100) of a region of interest (102). A subsurface (103) below the region of interest (102) may contain a reservoir (104). In general, seismic surveys may be configured in a myriad of ways. Therefore, the seismic survey (100) is not intended to be limiting with respect to the particular configuration of the seismic survey equipment or location. In FIG. 1, the seismic survey (100) is depicted as being on land, and a seismic source (106) is mounted on a land vehicle. In other examples, the seismic survey (100) may be offshore, and the seismic source mounted on a seismic vessel. Generally, the surface of the Earth, and thus, the region of interest (102) is curved. In one or more embodiments, the shape of the earth is modeled by a ellipsoid, the region of interest (102) is ellipsoidal and the region of interest (102) is transformed into a planar region of interest by means of a bi-dimensional projection from the ellipsoid to a planar surface. Examples of projections that may be used to transform the region of interest (102) into a planar region of interest include a universal transverse Mercator (UTM) projection. A UTM partitions an ellipsoid into several zones, and defines, for each zone, a projection that transforms the zone into a planar surface. The region of interest (102) is transformed into the planar region of interest by using the projection of the zone with which the region of interest (102) coincides the most. In this disclosure, the term “area of interest (102)” is also used to denote the planar region of interest into which the area of interest (102) is transformed using a projection and therefore, the region of interest (102) is considered planar. Using any point O on a plane [symbol] containing the region of interest (102) and two non-parallel axes coplanar to [symbol] , namely, an abscissa axis X and an ordinate axis [symbol] , any point on the surface of the Earth, such as a point in the region of interest (102), is represented by a pair of two coordinates (x, y), namely, an abscissa x and an ordinate y, on the coordinate system (O, X, [symbol] ). For concision, throughout this disclosure coordinates of a point on the surface of the Earth are assumed to be expressed in the coordinate system (O, X, [symbol] ), although other coordinate systems may be readily adopted and applied.

The seismic survey (100) may utilize the seismic source (106) on the surface of the earth that, when fired, generates radiated seismic waves (108), including pressure waves and shear waves, into the subsurface (103). In one or more embodiments, the seismic source (106) fires at a certain location, (xₛ, yₛ), for a certain duration, Tₛ, then stops. During the seismic survey (100), the seismic source (106) may fire multiple times, at different locations, hence illuminating the whole subsurface (103). In this disclosure, each activation of the seismic source (106), occurring at a distinct time, is also called a seismic source (106), and then, the seismic survey (100) is said to have multiple seismic sources. In one or more embodiments, the seismic source (106) is generated by a seismic vibrator, that may be mounted on a land vehicle. In other embodiments, the seismic source (106) is generated by an air gun, which may happen in marine seismic surveys. Part of the radiated seismic waves (108) may return to the surface as refracted seismic waves (110), or may be reflected by geological reflectors (112) and return to the surface as reflected seismic waves (114).

At the surface, seismic receivers (120) detect seismic waves of many kinds. Notable examples of seismic waves received by the seismic receivers (120) include the refracted seismic waves (110) and the reflected seismic waves (114) that return to the surface. Other examples of seismic waves that may be detected by the seismic receivers (120) include waves that reflect multiple times within the subsurface, known as multiple reflections, and waves that do not originate from the seismic source (106) that may be referred to as noise. Examples of noise that may be detected by the seismic receivers (120) include, depending on where the seismic survey (100) is located, ground roll, engine noise, swell noise, propeller noise, equipment damage noise and interferences from a seismic source from another seismic survey. Examples of seismic receivers (120) include geophones, hydrophones, or any combination thereof.

In one or more embodiments, each seismic receiver (120) includes a recorder, that records the amplitudes of the seismic waves detected by the seismic receiver (120) at a sequence of discreet times throughout the survey, the recorded amplitudes at each of these discreet times being called a sample. Then, for each seismic receiver (120), a seismic trace is defined. The seismic trace is an ordered set of samples recorded from a time when a seismic source is starts firing for a predefined duration, Tₘₐₓ, known as the trace length. Therefore, a distinct seismic trace is formed, for each seismic source activation and for each seismic receiver (120), as a time series of amplitudes recorded at discreet times discretizing a time interval of length Tₘₐₓ. In some embodiments, the trace length Tₘₐₓ is a fixed number of seconds selected between eight seconds and fourteen seconds. The set of discreet times discretizing the time interval for a seismic trace is called a time sampling of the seismic trace. For simplicity, the time interval, for each seismic trace, is translated to the interval [0, Tₘₐₓ], and each sample of the seismic trace is said occur at a certain time in the interval [0, Tₘₐₓ]. In one or more embodiments, the time sampling is constant for each seismic trace, and the time elapsed between two discreet times is called a sample rate of the seismic survey (100). Denoting (xₛ, yₛ) as the location of a seismic source (106) and (xᵣ, yᵣ) as the location of a seismic receiver (120), a seismic trace is localized by the four coordinates (xₛ, yₛ, xᵣ, yᵣ), and a sample of the seismic trace is localized by five coordinates, (xₛ, yₛ, xᵣ, yᵣ, t), where t denotes the time at which the sample occurs on the time interval [0, Tₘₐₓ]. The set of all seismic traces, for all seismic source positions and all seismic receivers constitutes a five-dimensional seismic dataset (“seismic data”).

A depth velocity model can be defined as an estimate of a speed of sound in the subsurface (103), or a portion of the subsurface (103). A seismic dataset may be processed to generate a depth velocity model of the subsurface (103) or an image of seismic reflectors within the subsurface (103). Seismic reflectors can represent geological boundaries, such as the boundaries between geological layers, the boundaries between different pore fluids, faults, fractures or groups of fractures within the rock. Generally, processing a seismic dataset comprises a sequence of steps designed, without limitation, to do one or more of the following: correct for near surface effects; attenuate noise; compensate for irregularities in the seismic survey geometry; calculate a depth velocity model; image reflectors in the subsurface; calculate a plurality of seismic attributes to characterize the subsurface (103), and aid in decisions governing where to drill for hydrocarbons.

Seismic traces of a seismic dataset, from a seismic survey, may be organized into groups called gathers. Examples of gathers include a seismic source gather. A seismic source gather is defined as a set of seismic traces that share a common seismic source. A seismic source gather includes seismic traces obtained from a single seismic source and all seismic receivers. Seismic traces grouped into seismic source gathers are said to be sorted in the seismic source domain. Examples of gathers further include a seismic receiver gather. A seismic receiver gather is defined as a set of seismic traces that share a common seismic receiver. A seismic receiver gather includes seismic traces obtained from all seismic sources and a single seismic receiver. Seismic traces grouped into seismic receiver gathers are said to be sorted in the seismic receiver domain. Examples of gathers further include a common midpoint (CMP) gather. To group seismic traces into CMP gathers, a midpoint for each trace is computed as a midpoint, (xₘ, yₘ) between the seismic source and the seismic receiver of that trace. The region of interest (102) is partitioned into a spatial CMP grid of spatial bins. A CMP gather is then defined as a set of traces with midpoints that lie within a same spatial bin. The CMP gather is then said to belong to a spatial bin, and the spatial bin is said to contain the CMP gather. Seismic traces grouped into CMP gathers are said to be sorted in the CMP domain. A seismic trace with a midpoint that falls within a spatial bin is said to belong to that spatial bin, and the spatial bin is said to contain the seismic trace. A location of a seismic trace is defined as the midpoint coordinates (xₘ, yₘ), and a location of a CMP gather is defined as a centroid of a spatial bin to which the CMP gather belongs. A seismic trace is said to be located at its location and a CMP gather is said to be located at its location. A spacing between locations of CMP gathers is called a CMP spatial sampling. The terms “CMP” and “CDP” can be used interchangeably.

For each seismic trace, a local coordinate system may be defined using the midpoint of the trace as an origin, a local abscissa axis X′, parallel to the abscissa axis X, and an ordinate axis, [symbol] ′, parallel to the ordinate axis [symbol] . Then, an x-offset, denoted as hₓ, is defined for the seismic trace as twice the abscissa of the seismic receiver of the seismic trace in the local coordinate system, and a y-offset, denoted as h_{y}, is defined for the seismic trace as twice the ordinate of the seismic receiver of the seismic trace in the local coordinate system. It is noted that the values of the x-offset, the y-offset, or both, might be positive or non-positive, and that a seismic trace may be localized by its midpoint and offset coordinates, (xₘ, yₘ, hₓ, h_{y}), instead of its seismic source and seismic receiver coordinates (xₛ, yₛ, xᵣ, yᵣ). An x-offset range may be partitioned into a first set of intervals called x-offset bins, the set of x-offset bins forming an x-offset grid. A center of an x-offset bin is called a value of the x-offset bin. A y-offset range may be partitioned into a second set of intervals called y-offset bins, the set of y-offset bins forming a y-offset grid. A center of a y-offset bin is called a value of the y-offset bin. A seismic trace whose values for the x-offset belongs to an x-offset bin is said to belong to that x-offset bin, and the x-offset bin is said to contain the seismic trace. A seismic trace whose values for the y-offset belongs to an y-offset bin is said to belong to that y-offset bin, and the y-offset bin is said to contain the seismic trace. Therefore, any seismic trace belongs to a unique spatial bin, a unique x-offset bin, and a unique y-offset bin. Furthermore, the spatial bins, the set of x-offset bins and the set of y-offset bins form a set of four-dimensional bins, and each seismic trace belongs to a unique four-dimensional bin. In some embodiments, the values of the x-offsets and y-offsets may be restricted in that seismic traces that belong to some selected x-offset bins and y-offset bins may be discarded from the seismic dataset prior to using the seismic dataset. A notable example consists of discarding seismic traces that belong to x-offset bins with values greater than a maximum x-offset bin threshold, discarding seismic traces that belong to x-offset bins with an absolute value less than a minimum x-offset bin threshold, discarding seismic traces that belong to y-offset bins with values greater than a maximum y-offset bin threshold and discarding seismic traces that belong to y-offset bins with an absolute value less than a minimum y-offset bin threshold. In scenarios in which some selected x-offset bins and y-offset bins are discarded from the seismic dataset prior to using the seismic dataset, the x-offset grid is the set of x-offset bins excluding the x-offset bins of the discarded seismic traces, and the y-offset grid is the set of y-offset bins excluding the y-offset bins of the discarded seismic traces. The set of spatial bins, the x-offset grid, and the y-offset grid form a four-dimensional grid of four-dimensional bins.

In one or more embodiments, the region of interest (102) is a polygon. The spatial bins can form a regular spatial CMP grid of rectangles with same height and width. Further, the x-offset bins each have a same first length, called x-offset spacing, forming a regular x-offset grid. Likewise, the y-offset bins each have a same second length, called y-offset spacing, forming a regular y-offset grid. The four dimensional grid formed by the set of the regular spatial bins, the regular x-offset grid, and the regular y-offset grid form a regular four-dimensional grid of regular four-dimensional bins.

A location of a seismic trace is defined as the midpoint coordinates (xₘ, yₘ), and a location of a CMP gather is defined as a centroid of a spatial bin to which the CMP gather belongs. A seismic trace is said to be located at its location and a CMP gather is said to be located at its location. Furthermore, a four-dimensional location of a seismic trace is defined as the coordinates (xₘ, yₘ, hₓ, h_{y}), and the seismic trace is also said to be located at (xₘ, yₘ, hₓ, h_{y}).

Generally, CMP gathers are irregular in that the number of seismic traces might be different for each CMP, and the location of each seismic trace might be different for each seismic trace within the same CMP gather. CMP gathers may further be irregular in that some four-dimensional bins may contain no seismic trace, a unique seismic trace, or multiple seismic traces. CMP gathers may further be irregular in that the x-offset values of seismic traces within a given CMP gather may be different from the x-offset values of seismic traces within another CMP gather. CMP gathers may further be irregular in that the y-offset values of seismic traces within a given CMP gather may be different from the y-offset values of seismic traces within another CMP gather.

CMP gathers may further be irregular in that two different x-offset values might belong to the same x-offset bin. CMP gathers may further be irregular in that two different y-offset values might belong to the same y-offset bins.

CMP gathers may be structured in many ways. In some embodiments, CMP gathers are structured by discarding all the seismic traces that do not fall within the four-dimensional grid, by keeping a maximum of one seismic trace per four-dimensional bin, and including a zero trace. In other words, a synthetic seismic trace with samples that all have a value of zero in bins that do not have any trace. Such CMP gathers have the same number of traces.

In some embodiments, the CMP gathers are regularized. To obtain regularized CMP gathers, the seismic traces of the seismic dataset may be interpolated into interpolated seismic traces located at the exact centroids of the four-dimensional bins. Then, the regularized CMP gathers are formed by sorting the interpolated seismic traces in the CMP domain. Examples of interpolation methods that may be used to interpolate seismic traces include a curvelet-domain interpolation, and a five-dimensional anti-leakage Fourier transform regularization. A five-dimensional anti-leakage Fourier transform regularization includes transforming all the seismic traces of into a frequency-wavenumber domain using a five-dimensional Fourier transform, and then, using a five-dimensional inverse Fourier transform, converting the transformed seismic traces from the frequency-wavenumber domain back into seismic traces located at the centroids of the four-dimensional bins. It is noted that seismic trace interpolation may be restricted to a maximum radius Ir, which means that no seismic trace will be interpolated into any bin center located at least at a distance Ir from all seismic traces. This may result in some of the four-dimensional bins having no seismic trace, even after seismic trace interpolation. In one or more embodiments, a zero trace is included into any bin that has no seismic trace after seismic trace interpolation. This way, all the regularized CMP gathers have the same number of traces, with regular location on the spatial grid, regular x-offset spacing on the x-offset grid, and regular y-offset spacing on the y-offset grid.

It is emphasized that the examples of binning, seismic trace interpolation methods, regularization methods, or any method to structure CMP gathers formulated herein are given only as examples and should not be considered limiting. One with ordinary skill in the art will recognize that other examples of binning, seismic trace interpolation methods, regularization methods, or any method to structure CMP gathers may be used without departing from the scope of this disclosure.

In one or more embodiments, the seismic traces of the seismic dataset are pre-processed. Example of pre-processing for seismic traces include, but are not limited to noise attenuation procedures, multiple reflection attenuation, ghost wavefield elimination, re-datuming, P-Z summation, shot and seismic receiver depth correction, frequency filtering, and spectral shaping. Some of the pre-processing steps may be done in different domains, such as the shot domain, seismic receiver domain, or CMP domain. Some of the pre-processing steps may be done multiple times and repeated in different domains, such as the shot domain, seismic receiver domain, or CMP domain. Some of the pre-processing steps may be done before interpolating the seismic traces, or after interpolating the seismic traces, or both. Some of the pre-processing steps may be done multiple times and repeated prior to interpolating the seismic traces and after interpolating the seismic traces. Generally, the pre-processing of the seismic traces is done according to pre-processing parameters. In one or more embodiments, the pre-processing parameters are obtained by doing a grid search. A grid search consists of scanning a plurality of values for one or more pre-processing parameters and selecting the values for one or more pre-processing parameters that produce the most desirable pre-processed seismic traces according to some quality control criteria. An example of a quality control criterion for a noise attenuation procedure is attenuating noise as much as possible without attenuating the signal coming from the reflected or refracted waves. In some scenarios, this is achieved by selecting a minimum noise attenuation threshold, selecting a maximum signal attenuation threshold, and selecting pre-processing parameters such that the attenuated noise is above the minimum noise attenuation threshold, where the signal coming from the reflected and refracted waves is attenuated less than the maximum signal attenuation threshold. An example of a quality control criterion for a spectral shaping procedure is that the pre-processed seismic traces have an amplitude frequency spectrum as flat as possible without increasing the amplitude of noise too much. In some scenarios, this is achieved by selecting a maximum frequency deviation threshold, selecting a maximum noise boosting threshold, and selecting pre-processing parameters such that the frequencies of the pre-processed seismic traces do not vary by more than the maximum frequency deviation threshold, where the difference of the amplitude of the noise after spectral shaping and the amplitude of the noise before spectral shaping is less than the noise boosting threshold.

In one or more embodiments, pre-processing the seismic traces includes using artificial intelligence (AI). Examples of AI models that may be used to pre-process seismic traces include classification algorithms, such as a decision tree, a support vector machine (SVM), or a neural network that flags traces that need to undergo a certain pre-processing step. Examples of AI models that may be used to pre-process seismic traces further include regression models, or neural networks that receive one or more input seismic traces as inputs and return, as output, an updated version of one or more input seismic traces after noise attenuation. It is emphasized that the examples of pre-processing processes and quality controls discussed herein are given only as examples and should not be considered limiting. One with ordinary skill in the art will recognize that other examples of pre-processing processes and quality controls may be used without departing from the scope of this disclosure.

Throughout this disclosure, a depth velocity model includes velocity traces and each velocity trace has a location, where the velocity trace is said to be located at its location. A spacing between locations of velocity traces is called a velocity spatial sampling. A set of velocity traces is said to have the velocity spatial sampling of the spacing between their locations. Consider a predefined maximum depth, Zₘₐₓ, and a depth sampling, zᵢ for i=1, . . . , N, that discretizes an interval [0, Zₘₐₓ] for some number of samples N≥2. Then, a velocity trace further includes, in addition of a location, a series of samples, vᵢ for i=1, . . . , N, where vᵢ is an estimate of a speed of sound at the location of the velocity trace, at depth zᵢ for i=1, . . . , N. In some implementations, it is assumed that all the velocity traces of a depth velocity model have the same depth sampling, z; for i=1, . . . , N. A value vᵢ is called a velocity amplitude at depth zᵢ, for i=1, . . . , N. A value vᵢ is also called a velocity sample at depth zᵢ, for i=1, . . . , N. The depth velocity model forms a three-dimensional volume of velocity samples, each velocity sample located at the location of a velocity trace, and at a one-dimensional depth zᵢ, for i=1, . . . , N. In one or more embodiments, each difference zᵢ₊₁−zᵢ is constant, for i=1, . . . , N−1, and called a depth sample spacing. The region of interest (102) is partitioned into a velocity grid of velocity bins, where the velocity grid may be equal to the spatial grid or the velocity grid may be a subset of the spatial grid. In some embodiments, the region of interest (102) is a polygon and the velocity bins form a regular spatial grid of rectangles with same height and width.

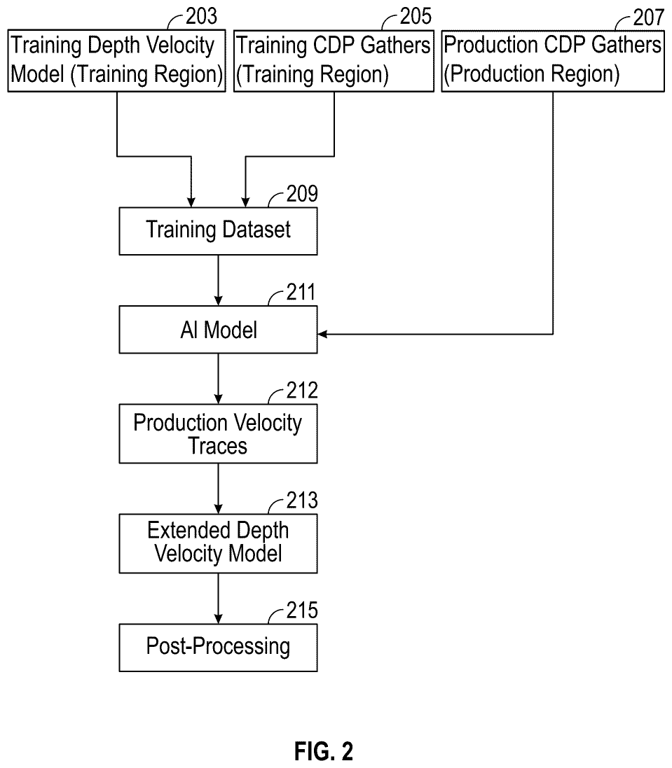

FIG. 2 depicts a system for producing an extended depth velocity model for the subsurface (103) below the region of interest (102). A training depth velocity model (203) of training velocity traces is obtained, where each velocity trace of the training depth velocity model (203) has a location in a sub-region included in the region of interest (102). The sub-region is called a training region. In one or more embodiments, the training region is considered much smaller than the region of interest (102), which means, for example, that a ratio between an area of the training region and an area of the region of interest (102) is smaller than a certain pre-defined training area threshold that is less than one. It is further assumed the training velocity traces are distinct and that the locations of all the training velocity traces form a partition of the training region. Training CDP gathers (205) are further obtained with a location within the training region. In one or more embodiments, the training CDP gathers (205) are obtained from the seismic dataset acquired in the seismic acquisition (1) by sorting seismic traces of seismic dataset in the CMP domain. As mentioned in other parts of this disclosure, the seismic traces may be pre-processed or regularized, or both, prior to being sorted in the CMP domain. In some scenarios, it may be useful to obtain a complete set of CDP gathers, located on a spatial grid that discretizes the whole area of interest (102), and then define the training CDP gathers (205) as the CDP gathers having a location in the training region. In other embodiments, the training CDP gathers (205) are obtained from another seismic project, called a legacy seismic project, that was previously completed in an area that includes the training area. In such scenarios, the training CDP gathers (205) might already be pre-processed and regularized. If not, the seismic traces from the legacy seismic project may be pre-processed or regularized, or both, prior to be sorted in the CMP domain to form the training CDP gathers (205). In one or more embodiments, the training depth velocity model (203) is obtained from another seismic project, called a legacy seismic project, that was previously completed in an area that includes the training area. In other embodiments, the training depth velocity model (203) is computed using the seismic dataset acquired in the seismic acquisition (1) and using one or more of a residual tomography algorithm, a full waveform inversion algorithm, and empirical editions.

It is assumed that the location of each training velocity trace coincides with a location of a unique CDP gather within the training CDP gathers (205). In some embodiments, a preliminary depth velocity model is obtained of preliminary velocity traces whose locations do not coincide with locations of CDP gathers within the training CDP gathers (205), and the training depth velocity model (203) is obtained by interpolating the preliminary depth velocity model to locations that coincide with CDP gathers within the training CDP gathers (205). Examples of interpolation methods that may be used to interpolate the preliminary depth velocity model include polynomial interpolation methods such as a linear or a bilinear interpolation method.

A train-test dataset of examples is formed, each example including an input and an associated output (ie: target), where the input is a CDP gathers from the training CDP gathers (205) and the associated output is a training velocity trace of the training depth velocity model (203) located at the same location as the input. In one or more embodiments, the train-test dataset is split into a training dataset (209) and a testing dataset, the examples within the training dataset (209) being called training examples, and the examples within the testing dataset being called testing examples. It is common practice to split the train-test dataset in a way that the training dataset (209) contains more examples than the testing dataset. Because data splitting is a common practice when training and testing a machine-learned model, it is not described in detail in this disclosure. One with ordinary skill in the art will recognize that any data splitting technique may be applied to the train-test dataset without departing from the scope of this disclosure. In some embodiments, the training dataset (209) is the whole train-test dataset.

An AI model (211) is trained as a functional mapping that optimally matches the inputs of the training examples to the associated outputs of the training examples. Thus, the AI model (211) is trained to receive a CDP gather as input, and return, as output, a velocity trace having the same location as the input CDP gather. Examples of AI models that may be used as the AI model (211) include supervised machine learning models such as random forest, polynomial regression, neural network (NN), or any combination thereof. Notable examples of neural network that may be included in the AI model (211) include a deep neural network (DNN), a convolutional neural network (CNN), or a recurrent neural network (RNN), a long-short term memory (LSTM) network, or any combination thereof. In one or more embodiments, the AI model (211) is validated by computing a metric for the testing examples. Examples of metrics that may be used to validate the AI model (211) include any scoring or comparison function known in the art, including but not limited to: mean square error (MSE), root mean square error (RMSE), and coefficient of determination (R2). These comparison functions are defined as:

$$MSE = \frac{1}{n} {\sum }_{i = 1}^{i = n} {\vert {\hat{y}}_{i} - {y}_{i} \vert}^{2} , \qquad EQ . 1$$

$$RMSE = \sqrt{\frac{1}{n} {\sum }_{i = 1}^{i = n} {\vert {\hat{y}}_{i} - {y}_{i} \vert}^{2}} , \qquad EQ . 2$$

$${R}^{2} = 1 - \frac{{\sum }_{i = 1}^{i = n} {\vert {\hat{y}}_{i} - {y}_{i} \vert}^{2}}{{\sum }_{i = 1}^{i = n} {\vert {y}_{i} - \overline{y} \vert}^{2}} . \qquad EQ . 3$$

In EQ. 1, EQ. 2, and EQ. 3, n denotes the number of testing examples, each training example being defined as an input-output pair, (xᵢ, yᵢ), for i=1, . . . , n, in which xᵢ is the input, yᵢ is the output associated with xᵢ. Further, y is the average output over the testing examples

$$( i . e . , y = \frac{1}{n} {\sum }_{i = 1}^{i = n} {y}_{i} )$$

and ŷᵢ denotes the value of the predicted velocity trace by the AI model (211) when receiving xᵢ as input, for i=1, . . . , n. The notation |⋅| denotes a norm that may be applied to a series, such as an l₂ norm.

Production CDP gathers (207) are obtained from the seismic datasets acquired by the seismic survey (1). The locations of the production CDP gathers (207) discretize a production region that includes, at least, the difference between the region of interest (102) and the training region. Thus, the production region may be the whole region of interest (102), or it may exactly the difference between the region of interest (102) and the training region, or it may include a part of the training region and difference between the region of interest (102) and the training region. The production CDP gathers (207) may be obtained by sorting seismic traces of seismic dataset in the CMP domain. As mentioned in other parts of this disclosure, the seismic traces may be pre-processed or regularized, or both, prior to being sorted in the CMP domain. In some scenarios, it may be useful to obtain a complete set of CDP gathers, located on a spatial grid that discretizes the whole area of interest (102), and then define the production CDP gathers (207) as the CDP gathers having a location in the production region. The production CDP gathers (207) are intended to be used as input to the AI model (211) and therefore the production CDP gathers (207) may need to be re-formatted, in accordance with some embodiments. Example of re-formatting that may be done to the production CDP gathers (207) include re-sampling the production CDP gathers (207) to the same time sampling rate as the training CDP gathers (205) or adjusting the trace length of the production CDP gathers (207) to the same trace length as the training CDP gathers (205).

Production velocity traces (212) are computed by applying the AI model (211) to each production CDP gather within the production CDP gathers (207), that returns, as output, a production velocity trace located at the same location as the training CDP gather. The locations of the production velocity traces (212) discretize the production region. An extended depth velocity model (213) is defined as the union of the production velocity traces (212) and all training velocity traces, within the training depth velocity model (203), located within the difference between the region of interest (102) and the production region. In a specific scenario for which the production region is the whole region of interest (102), the difference between the region of interest (102) and the production region is empty and the extended depth velocity model (213) is the set of production velocity traces (212). In a specific scenario for which the production region is exactly the difference between the region of interest (102) and the training region, the difference between the region of interest (102) and the production region is exactly the training region and the extended depth velocity model (213) is composed of the production velocity traces (212) and all the training velocity traces from the training depth velocity model (203). The locations of the velocity traces from the extended depth velocity model (213) discretize the region of interest (102) and the extended depth velocity model (213) is said to be a depth velocity model for the region of interest (102).

In one or more embodiments, the extended depth velocity model (213) goes through post-processing (215). Examples of post-processing (215) include an interpolation of the extended depth velocity model (213) to a pre-defined, regular velocity grid. In some scenarios, for instance, in which the training depth velocity model (203) is obtained from a legacy seismic project, the production velocity traces (212) may not have the same velocity spatial sampling as the training depth velocity model (203). If, in addition, the extended depth velocity model (213) is a union between the production velocity traces (212) located in the production region and some training velocity traces, within the training depth velocity model (203), located outside the production region, the extended depth velocity model (213) may have a different velocity spatial spacing inside the production region and outside the production region. Interpolating the extended depth velocity model (213) to locations on a regular velocity grid within the whole region of interest (102) results in the extended depth velocity model (213) having a regular velocity spatial spacing in the whole region of interest (102).

In one or more embodiments, a determination whether the extended depth velocity model (213) needs to be post-processed is made using a quality control procedure. An example of a quality control procedure that may be used to determine whether the extended depth velocity model (213) needs to be post-processed is a visual inspection. A visual inspection may include looking at the extended depth velocity model (213) in a cross-sectional direction, or looking at a depth slice of the extended depth velocity model (213), defined by all the samples of the extended depth velocity model (213) at a fixed depth zᵢ, for a given index i∈[1, N]. If an anomaly is detected during the visual inspection, the extended depth velocity model (213) may need to be post-processed. Examples of anomalies that may be detected during a visual inspection include velocity amplitudes that are unreasonably low or reasonably high. As an example, knowledge of a geological formation in the region of interest (102) may be used to impose restrictions on a range of the speed of sound in the subsurface (103), meaning that the speed of sound in the in the subsurface (103) should belong to a velocity interval [Vₘᵢₙ, Vₘₐₓ]. In such scenarios, a velocity amplitude may be said to be unreasonably low if it is less than Vₘᵢₙ, or it may be said to be unreasonably high if it is greater than Vₘₐₓ. An example of a post-processing step that may be applied to the extended depth velocity model (213) to alter amplitudes that are unreasonably low or unreasonably high is clipping the velocity amplitudes of the extended depth velocity model (213) to restrict the velocity amplitudes to the given range.

Other examples of anomalies that may be detected during a visual inspection include an amplitude variation from one velocity sample to another, or from a first velocity trace to a group of neighboring velocity traces, or both, that is considered too large. In accordance with one or more embodiments, an amplitude variation between two samples is considered too large if an absolute value of a difference of the velocity amplitude at one of the two samples and the velocity amplitude at the other of the two samples is greater than a predefined velocity amplitude threshold. In accordance with one or more embodiments, an amplitude variation between a first velocity trace and a group of neighboring velocity traces is considered too large if an absolute value of a difference between a norm, such as the l₂ norm, of the first velocity trace and an average of the norms of the velocity traces within the group of neighboring velocity traces is greater than a predefined norm threshold. In scenarios in which the training depth velocity model (203) is obtained from a legacy seismic project, there may be an amplitude variation between the training velocity traces and the production velocity traces (212). In these scenarios, if the extended depth velocity model (213) additionally includes some training velocity traces, an amplitude variation might be observed at the boundary of the training region where production velocity traces have training velocity traces as neighboring traces. An examples of a post-processing step that may be applied to the extended depth velocity model (213) to reduce amplitude variations is smoothing the extended depth velocity model (213).

Another example of a quality control procedure that may be used to determine whether the extended depth velocity model (213) needs to be post-processed further is a coherency analysis. In one or more embodiments, a coherency analysis includes computing a coherency metric for each velocity sample of the extended depth velocity model (213), such as a semblance, and detecting samples for which the coherency metric is too low. In accordance with some embodiments, determining that a coherency metric is too low includes comparing the coherency metric of a velocity sample to a pre-defined coherency threshold. For example, in the case where the coherency metric for the velocity sample is lower than the coherency threshold, it may be concluded that additional post-processing is recommended. An examples of a post-processing step that may be applied to the extended depth velocity model (213) to increase the coherency is smoothing the extended depth velocity model (213).

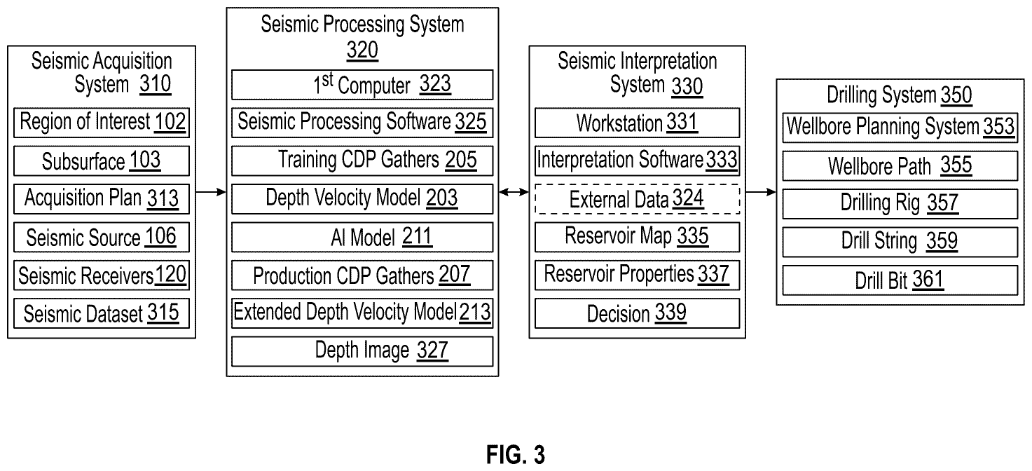

FIG. 3 depicts a system for finding a potential hydrocarbon reservoir and drilling a well that perforates the reservoir. For concision, a full description of components and/or elements depicted in FIG. 3 is not provided anew for those components and/or elements that have been previously described with reference to the preceding figures. FIG. 3 includes a seismic acquisition system (310), a seismic processing system (320), a seismic interpretation system (330), and a drilling system (350). The seismic acquisition system (310) is designed to acquire a seismic dataset (315) according to an acquisition plan (313). The acquisition plan (313) defines a seismic survey, such as the seismic survey described in FIG. 1, and includes positions of the seismic source (106) and the seismic receivers (120) in a way that the subsurface (103) below the region of interest (102) is illuminated by the seismic source (106). Further, the seismic survey is configured such that a seismic dataset (315) recorded by the seismic receivers (120) can be used by the seismic processing system (320) to image the subsurface (103). Generally, the seismic source (106) may be activated multiple times, at different locations. The acquisition plan (313) may further include a timeline for the acquisition, equipment to be used to run the survey, and human resources.

The seismic source (106) and seismic receivers (120) may be of various types. In one or more embodiments, the region of interest (102) is located onshore and the seismic source (106) is a seismic vibrator (e.g., mounted on a land vehicle) and the seismic receivers (120) are geophones. A land vehicle may carry the seismic source to different locations to complete the seismic acquisition. The geophones may also be moved anytime during the seismic acquisition, by humans or another vehicle. In other embodiments, the region of interest (102) is located offshore and the seismic source (106) is an array of air guns mounted on a seismic vessel. In these embodiments, during the seismic acquisition, the seismic source (106) is moved to different locations via the motion of the seismic vessel. Additionally, the seismic receivers (120) may be geophones, hydrophones, or a combination thereof. The seismic receivers (120) may be located inside cables that are towed by the seismic vessel, or inside ocean bottom nodes (OBN). During a seismic acquisition using OBN, the OBN may be moved to different locations by a machine. Generally, a geophone records a velocity of seismic waves, such as a pressure wave or a shear wave, that reach the geophone. Generally, a hydrophone records a pressure of seismic waves that reaches the hydrophone. It is emphasized that the examples of seismic acquisition and equipment used for the seismic acquisition herein are given only as examples and should not be considered limiting. One with ordinary skill in the art will recognize that other examples of seismic acquisition and equipment used for the seismic acquisition may be used without departing from the scope of this disclosure.

The seismic dataset (315) may be of various types. In some embodiments, the seismic dataset (315) includes records of a pressure of a seismic wave. In other embodiments, the seismic dataset (315) is a multi-component dataset and may include a velocity of a seismic wave in each of one, two, or three spatial dimensions. In further embodiments, the seismic dataset (315) is a multi-component dataset and may include a pressure and a velocity of a seismic wave in each of one, two, or three spatial dimensions.

The seismic processing system (320) includes seismic processing software (325), that is hosted and run on a first computer (323). Seismic processing software (325) may include seismic trace processing tools, such as tools for performing noise attenuation, multiple attenuation, ghost wavefield elimination, re-datuming, P-Z summation, shot and seismic receiver depth correction, frequency filtering, and spectral shaping. Seismic processing software (325) may further include sorting algorithms for sorting seismic traces into different domains, such as the previously described shot domain, seismic receiver domain, and CMP domain. As stated in other paragraphs of this disclosure, the seismic processing system (320) may further make use of AI to perform some of the processing tasks.

Seismic processing software (325) may further include procedures for computing an image of the subsurface (103), from the seismic traces, including migration algorithms, that receive the seismic dataset (315) and a depth velocity model as input. Examples of migration algorithms include a Kirchhoff migration, a reverse-time migration (RTM), and a beam migration. A Kirchhoff migration algorithm is designed to find all the possible locations, within the subsurface (103), from where the reflected seismic waves (114) recorded in a seismic trace might have come based on the times at which the reflected seismic waves (114) are recorded on the seismic trace. The locations from where reflected seismic waves (114) might have come can indicate positions of seismic reflectors in the subsurface (103). A beam migration algorithm is designed to find all the possible locations within the subsurface (103) from where the reflected seismic waves (114) recorded in a set of a predefined number of seismic traces from adjacent seismic receivers might have come, based on the times at which the reflected seismic waves (114) are recorded on each trace within the set of seismic traces from adjacent seismic receivers. The locations from where reflected seismic waves (114) might have come cam indicate positions of seismic reflectors in the subsurface (103). By including a set of seismic traces from adjacent seismic receivers as input, beam migration receives information of a delay with which the reflected seismic waves (114) arrive at each adjacent seismic receiver, which might indicate an inclination of seismic reflectors in the subsurface (103). A RTM algorithm includes propagating a downgoing wavefield through the subsurface (103) from the seismic source positions using a wave equation, and backpropagating, as an upgoing wavefield, the seismic traces through the subsurface (103) from the seismic receiver positions using the wave equation. Then, an imaging condition may indicate positions of seismic reflectors within the subsurface (103) by matching locations where the downgoing wavefield and the upgoing wavefield meet.

Seismic processing software (325) may further include velocity model building tools for computing a depth velocity model of the subsurface (103). Examples of velocity model building tools include, but are not limited to, a residual moveout (RMO) tomography, a full waveform inversion (FWI), and velocity edition algorithms. A residual moveout tomography is an inversion algorithm that computes a depth velocity model such that positions of seismic reflectors would be the same on any image obtained by applying a migration algorithm to seismic traces with a distinct x-offset and a distinct y-offset. In some embodiments, a RMO tomography algorithm includes a wave propagation algorithm, such as a wave ray tracing algorithm. An FWI algorithm is an inversion algorithm that computes a depth velocity model such that a synthetic wavefield, propagated using the depth velocity model from the positions of the seismic source (106) to the positions of the seismic receivers (120), is equal to the seismic dataset (315). Many variations of RMO tomography algorithms and FWI algorithms exist, including having different cost functions, or using different wavefield propagation algorithms. Examples of velocity edition algorithms include velocity smoothing algorithms, velocity interpolation algorithms, and mathematical operators for obtaining or modifying a depth velocity model arbitrarily.

Seismic processing software (325) may further include visualization software. Visualization software may include various functions allowing for observing seismic traces and depth velocity models. In one or more embodiments, visualization software includes quality control tools, such as algorithms to compute a frequency spectrum, compute a frequency-wavenumber spectrum, sort seismic traces into various domains, compare two different datasets, or compute statistics on seismic data or a depth velocity model. In one or more embodiments, visualization software further includes processing tools, such as frequency filters, and algorithms to scale amplitudes of seismic traces, smooth depth velocity models, or interpolate depth velocity models.

One with ordinary skill in the art will recognize that the examples of components or functions of the seismic processing software (325) described herein, including processing procedures, migration algorithm, velocity model building tools, and visualization software are intended to promote clear discussion and should not be considered fixed or limiting. The seismic processing software (325) may include fewer or additional components from the above-described components without departing from the scope of this disclosure.

In some embodiments, the seismic processing software (325) receives the training CDP gathers (205) located in a training region from a legacy seismic project. In other embodiments, the seismic processing software (325) produces the training CDP gathers (205), located in the training region, from the seismic dataset (315) as described with respect to FIG. 2. The training depth velocity model (203) for the training region may be obtained from a legacy seismic project or be computed by using tools within the seismic processing software (325), such as a RMO tomography algorithm, a FWI algorithm, velocity editions, or any combination thereof. In further scenarios, the training depth velocity model (203) is computed by refining, using tools within the seismic processing software (325), a depth velocity model obtained from a legacy seismic project. In one or more embodiments, the seismic processing system (320) further includes the AI model (211). The AI model (211) is trained using the training CDP gathers (205) and the training depth velocity model (203) and applied to the production CDP gathers (207) to obtain the extended depth velocity model (213). The extended depth velocity model (213) may further be post-processed using the seismic processing software (325).

Generally, one or more quality control (QC) procedures are performed on the extended depth velocity model (213). Examples quality control procedures include, as described in the description of FIG. 2, a visual inspection and a coherency analysis. In one or more embodiments, a well log analysis is performed, as a quality control procedure, to validate the extended depth velocity model (213). In cases where a well exists in the region of interest (102) and a depth sonic log is available for the well, a modeled velocity trace may be obtained from the extended depth velocity model (213) located at the well location. The modeled velocity trace can be compared with the depth sonic log to compute a velocity mismatch between the modeled velocity trace and the depth sonic log. The modeled velocity trace may be obtained by extracting a velocity trace from the extended depth velocity model (213) if a velocity trace within the extended depth velocity model (213) has a location that coincides with the well location. Otherwise, if no velocity trace within the extended depth velocity model (213) has a location that coincides with the well location, the modeled velocity trace may be obtained by interpolating, for example using a polynomial interpolation algorithm, the extended depth velocity model (213) onto the well location. In one or more embodiments, a velocity mismatch between the modeled velocity trace and the depth sonic log is computed as a distance between the modeled velocity trace and the depth sonic log. Examples of distances that may be computed between the modeled velocity trace and the depth sonic log includes a lₚ-norm of a difference between the modeled velocity trace and the depth sonic log, with p∈[1, ∞]. Note that prior to computing the difference, the modeled velocity trace may be re-sampled to the depth sampling of the depth sonic log, or the depth sonic log may be re-sampled to the depth sampling of the modeled velocity trace. In one or more embodiments, the velocity mismatch is compared with a pre-defined similarity threshold. A well log validation is then defined as positive if the velocity mismatch is less than or equal to the similarity threshold, and negative if the velocity mismatch is greater than the similarity threshold. If the well log validation is positive, the extended depth velocity model (213) may be used in a migration algorithm, included in the seismic processing software (325), to compute a depth image (327) of the subsurface (103).

In some embodiments, the extended depth velocity model (213) goes through further quality control criteria to be validated. In that regard, further quality control criteria may include defining the model as validated if a coherency of the extended depth velocity model (213) is greater than a coherency threshold, in accordance with one or more embodiments. If several depth sonic logs are available in the region of interest (102), the quality control criteria may further include performing a well log analysis for each well. Then, the extended depth velocity model (213) may be considered as validated if all the well log validations are “positive” (i.e., within given similarity thresholds). In other implementations, extended depth velocity model (213) may be considered as validated if a ratio between the number of positive well log validations and the number of negative well log validations is greater than or equal to a predefined well log ratio threshold. If the extended depth velocity model (213) is validated, the extended depth velocity model (213) is used in a migration algorithm, included in the seismic processing software (325), to compute a depth image (327) of the subsurface (103). If the extended depth velocity model (213) is not validated, further analysis may be performed in order to determine why the extended depth velocity model (213) is inaccurate (according to the quality control criteria) and an action may be taken to alter or re-compute the extended depth velocity model (213). In some embodiments, the action includes further post-processing performed on the extended depth velocity model (213) including multiplying the extended depth velocity model (213) by a three-dimensional scalar to force the extended depth velocity model (213) to be similar to the depth sonic logs around the well locations. In other embodiments, the AI model (211) may be re-trained or fine-tuned using a different set of hyperparameters than the ones that were used to previously train the AI model (211).

The seismic interpretation system (330) is used by geoscientists, seismic interpreters, and exploration teams to analyze the depth image (327) and the extended depth velocity model (213). The seismic interpretation system (330) includes a workstation (331) that allows seismic interpreters to visualize the depth image (327) and the extended depth velocity model (213). Seismic interpreters may use interpretation software (333), hosted and run on the workstation (331), to perform various interpretation tasks. An example of an interpretation task includes interpreting key geological horizons within the depth image (327) that delimit stratigraphic layers, boundaries, and structural features of the subsurface (103). In that respect, the interpretation software (333) may be equipped with various horizon picking tools, such as, for example, a hand-picking tool that allows a seismic interpreter to draw lines on the depth image (327) and an automatic horizon tracking algorithm. An automatic horizon tracking algorithm allows an interpreter to pick a geological event at a limited number of discreet points, called seed points, in the depth image (327) and then let the automatic horizon tracking algorithm track the geological event from these seed points, resulting in a horizon. In some embodiments, the interpretation software (333) further includes a machine learning model that receives a depth image as input and returns, as output, a horizon, or a piece of a horizon.

Examples of interpretation tasks further include computing seismic attributes of the depth image (327), such as a frequency, a gradient, an envelope, or a coherency. The workstation (331) may further include peripherals such as a monitor, a keyboard, a mouse, and a graphic tablet that enable efficient interaction between seismic interpreters to interact with the interpretation software (333).

In one or more embodiments, a well-tie analysis is performed as a quality control procedure to validate the extended depth velocity model (213). In cases where a well exists in the region of interest (102) and a well marker is available for a geological event for the well, a horizon may be interpreted on the depth image (327). In these cases, the horizon tracks the geological event in the vicinity of the well. As such, a depth mismatch may be computed as an absolute value of a difference between the horizon at the well location and the well marker depth. In one or more embodiments, the depth mismatch is compared against a pre-defined depth matching threshold. Then, the horizon is considered as close to the well marker depth if the depth mismatch is less than or equal to the depth matching threshold, or not close if the depth mismatch is greater than the depth matching threshold. The depth matching threshold may be defined, for instance, as an arbitrary value or as a percentage of the well marker depth (e.g., one percent of the well marker depth). In some scenarios, determining that the horizon is considered close to the well marker depth validates the depth image (327) to be used in the seismic interpretation system (330) to localize a hydrocarbon reservoir within the subsurface (103). In scenarios where the horizon is not close to the well marker depth, the extended depth velocity model (213) and depth image (327) may be sent back to the seismic processing system (320) for further quality control or refinements.

Results of the interpretation tasks may enable seismic interpreters to locate a potential hydrocarbon reservoir in the subsurface (103) and produce a reservoir map (335) for the potential hydrocarbon reservoir. In one or more embodiments, localization of the potential hydrocarbon reservoir and production of the reservoir map (335), may further be based on external data (324). Examples of external data (324) include well-log data, geological knowledge, and other geophysical information of the subsurface (103) below the region of interest (102).

In one or more embodiments, reservoir properties (337) are determined for the potential hydrocarbon reservoir, using the depth image (327), or the extended depth velocity model (213). Examples of reservoir properties (337) that may be determined for the potential hydrocarbon reservoir include, but are not limited to, a hydrocarbon distribution within the potential hydrocarbon reservoir, reservoir rock properties, a volume of hydrocarbon within the potential hydrocarbon reservoir, a performance of the potential hydrocarbon reservoir, and a risk assessment. According to the potential reservoir map (335) and the reservoir properties (337), a decision (339) may be made to drill a well perforating the potential hydrocarbon reservoir. In one or more embodiments, the decision (339) of drilling a well perforating the potential hydrocarbon reservoir is taken by stakeholders associated with hydrocarbon industry, such as seismic interpreters, geologists and an oil and gas company management.

Following the decision (339), the reservoir map (335), reservoir properties (337), and other results of the interpretation tasks, such as a structural mapping of the subsurface (103), may be transferred to a wellbore planning system (353) that is part of a drilling system (350). The wellbore planning system (353) may use that information to plan a hydrocarbon well drilling operation, the plan including a wellbore path (355) from the surface of the earth to penetrate the potential hydrocarbon reservoir. The wellbore planning system (353) further assists drilling engineers and teams in making strategic decisions to optimize the wellbore path (355) and placement, to design the casing, and to avoid geohazards, based on geological formations and structural complexities. In some embodiments, the wellbore path (355) may further be constrained by surface limitations, such as suitable locations for the surface position of the wellhead, availability and configuration of drilling ships, and the layout of natural or man-made islands. Additionally, the locations of potential or preexisting drilling rigs may be considered. Drilling equipment is then installed around the entrance of the wellbore path (355) in order to perform a drilling operation to perforate the potential hydrocarbon well. Drilling equipment may include a drill bit (361) that perforates the subsurface (103). Drilling equipment may further include a drilling rig (357) to suspend a drill string (359), the drill bit (361) mounted on a downhole or distal end of the drill string (359). Greater details surrounding drilling operations are described later in this disclosure.

As stated, the extended depth velocity model (213) includes the production velocity traces (212) that are computed using the AI model (211). Artificial intelligence (AI), broadly defined, is the extraction of patterns and insights from data. The phrases “artificial intelligence,” “machine learning,” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence will be adopted herein, however, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

A notable example of an AI model that may be used as AI model (211) is a neural network (NN), such as a convolutional neural network (CNN) or a recurrent neural network (RNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

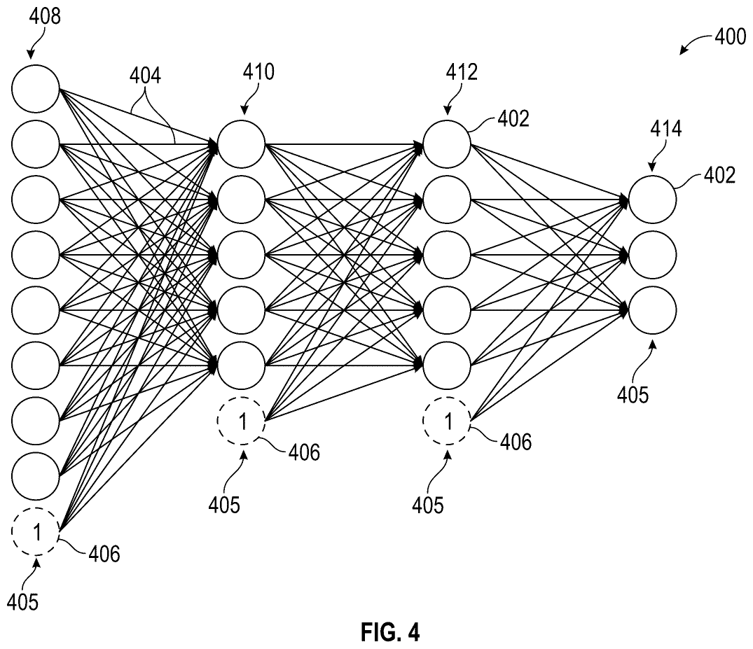

A diagram of a neural network is shown in FIG. 4. At a high level, a neural network (400) may be graphically depicted as being composed of nodes (402), where here any circle represents a node, and edges (404), shown here as directed lines. The nodes (402) may be grouped to form layers (405). FIG. 4 displays four layers (408, 410, 412, 414) of nodes (402) where the nodes (402) are grouped into columns, however, the grouping need not be as shown in FIG. 4. The edges (404) connect the nodes (402). Edges (404) may connect, or not connect, to any node(s) (402) regardless of which layer (405) the node(s) (402) is in. That is, the nodes (402) may be sparsely and residually connected. A neural network (400) will have at least two layers (405), where the first layer (408) is considered the “input layer” and the last layer (414) is the “output layer.” Any intermediate layer (410, 412) is usually described as a “hidden layer.” A neural network (400) may have zero or more hidden layers (410, 412) and a neural network (400) with at least one hidden layer (410, 412) may be described as a “deep” neural network or as a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The edge numerical values, or even the edges (404) themselves, are often referred to as “weights” or “parameters.” While training a neural network (400), numerical values are assigned to each edge (404). Additionally, every node (402) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ . 4$$

where i is an index that spans the set of “incoming” nodes (402) and edges (404) and ƒ is a user-defined function. Incoming nodes (402) are those that, when the neural network (400) is viewed or depicted as a directed graph (as in FIG. 4), have directed arrows that point to the node (402) where the numerical value is being computed. Some functions for f may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (402) in a neural network (400) may have a different associated activation function. Often, as a shorthand, activation functions are described by the function f by which it is composed. That is, an activation function composed of a linear function f may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), displayed in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Training data is provided to the neural network (400). Generally, training data consists of pairs of inputs and associated targets. The targets represent the “ground truth,” or the otherwise desired output, upon processing the inputs. In the context of the AI model (211), an input is a training CDP gather within the training CDP gathers (205), with a location in the training region. An output, or target, is a training velocity trace from the training depth velocity model (203) at the same location ats the CDP gather. During training, the neural network (400) processes at least one input from the training data and produces at least one output. Each neural network (400) output is compared to its associated input data target. The comparison of the neural network (400) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (400) output and the associated target. The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target over the training data. Thus, the loss function is used to guide changes made to the edge (404) values, typically through a process called “backpropagation.”

While a full review of the backpropagation process exceeds the scope of this disclosure, a brief summary is provided. Backpropagation consists of computing the gradient of the loss function over the edge (404) values. The gradient indicates the direction of change in the edge (404) values that results in the greatest change to the loss function. Because the gradient is local to the current edge (404) values, the edge (404) values are typically updated by a “step” in the direction indicated by the gradient. The step size is often referred to as the “learning rate” and need not remain fixed during the training process. Additionally, the step size and direction may be informed by previously seen edge (404) values or previously computed gradients. Such methods for determining the step direction are usually referred to as “momentum” based methods.

Once the edge (404) values have been updated, or altered from their initial values, through a backpropagation step, the neural network (400) will likely produce different outputs. Thus, the procedure of propagating at least one input through the neural network (400), comparing the neural network (400) output with the associated target with a loss function, computing the gradient of the loss function with respect to the edge (404) values, and updating the edge (404) values with a step guided by the gradient, is repeated until a termination criterion is reached. Common termination criteria are: reaching a fixed number of edge (404) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (404) values are no longer intended to be altered, the neural network (400) is said to be “trained.”

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship. Like unto the neural network (400), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (400) to produce a final output. Note, that in this context, the neural network (400) is still considered part of the CNN. Like unto a neural network (400), a CNN is trained, after initialization of the filter weights, and the edge (404) values of the internal neural network (400), if present, with the backpropagation process in accordance with a loss function.

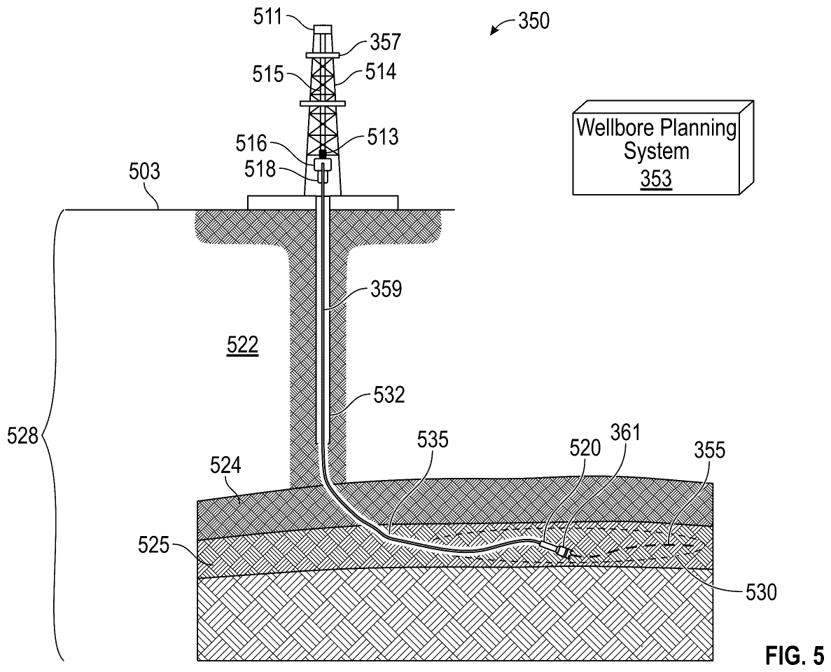

FIG. 5 shows a drilling system (350) in accordance with one or more embodiments. As shown in FIG. 5, a wellbore (535) following the wellbore path (355) may be drilled by a drill bit (361) attached by a drill string (359) to a drilling rig (357) located on the surface of the earth. The drilling rig (357) may include framework, such as a derrick (514) to hold drilling machinery. A crown block (511) may be mounted at the top of the derrick (514), and a traveling block (513) may hang down from the crown block (511) by means of a cable (515) or drilling line. One end of the cable (515) may be connected to a drawworks (not shown), which is a reeling device that may be used to adjust the length of the cable (515) so that the traveling block (513) may move up or down the derrick (514).

A top drive (516) provides clockwise torque via the drive shaft (518) to the drill string (359) in order to drill the wellbore (535). The drill string (359) may comprise a plurality of sections of drillpipe attached at an uphole end to the drive shaft (518) and downhole to a bottomhole assembly (“BHA”) (520). The BHA (520) may be composed of a plurality of sections of heavier drillpipe and one or more measurement-while-drilling (“MWD”) tools configured to measure drilling parameters. Measured drilling parameters may include torque, weight-on-bit, drilling direction, temperature, etc. Additionally, the BHA may have one or more logging tools (e.g., logging-while-drilling (“LWD”)) configured to measure parameters of the rock surrounding the wellbore (535), such as electrical resistivity, density, sonic propagation velocities, gamma-ray emission, etc. MWD tools and logging tools may include sensors and hardware to measure downhole drilling parameters, and these measurements may be transmitted to the surface (503) using any suitable telemetry system known in the art. The BHA (520) and the drill string (359) may include other drilling tools known in the art but not specifically shown.

The wellbore (535) may traverse a plurality of overburden (522) layers and one or more formations (524) to a potential hydrocarbon reservoir (525) within the subsurface (528), and specifically to a drilling target (530) within the potential hydrocarbon reservoir (525). The wellbore path (355) may be a curved or a straight trajectory. All or part of the wellbore path (355) may be vertical, and some parts of the wellbore path (355) may be deviated or have horizontal sections. One or more portions of the wellbore (535) may be cased with casing (532) in accordance with a wellbore plan.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. The drilling system (350) may be used to drill the wellbore (535) along the planned wellbore path (355) to access the drilling target (530) in the potential hydrocarbon reservoir (525).

To start drilling, or “spudding in” the well, the hoisting system lowers the drill string (359) suspended from the derrick (514) towards the planned surface location of the wellbore (535). An engine or electric motor may be used to supply power to the top drive (516) to rotate the drill string (359) through the drive shaft (518). The weight of the drill string (359) combined with the rotational motion enables the drill bit (361) to bore the wellbore (535).

The drilling system (350) may be disposed at and communicate with other systems in the well environment, such as the seismic processing system (320) and the seismic interpretation system (330) defined in the description of FIG. 3. The drilling system (350) may control at least a portion of a drilling operation by providing controls to various components of the drilling operation. In one or more embodiments, the drilling system (350) may receive well data from one or more sensors and/or logging tools arranged to measure controllable parameters of the drilling operation. During operation of the drilling system (350), the well data may include mud properties, flow rates, drill volume and penetration rates, rock physical properties, etc.

The wellbore planning system (353) helps drilling engineers in designing casing strings and selecting appropriate tubulars based on the wellbore conditions, planned drilling operations, and regulatory requirements. It considers factors such as pressure, temperature, well depth, formation properties, and casing load capacity. Furthermore, the wellbore planning system (353) performs torque and drag analysis to evaluate the forces and stresses acting on the drill string (359) during drilling operations. This analysis helps in identifying potential issues such as differential sticking, buckling, or limitations in the drilling equipment. The wellbore planning system (353) may have the capability to integrate real-time drilling data, such as downhole measurements, drilling parameters, and formation evaluation results. This integration allows engineers to monitor the drilling progress, make on-the-fly adjustments to the well plan, optimize drilling efficiency, and maintain drilling safety. The wellbore planning system (353) further allows drilling engineers to visualize and interact with wellbore data in a 3D environment. It provides a graphical representation of the planned well trajectory, existing well paths, geological formations, and potential hazards. Furthermore, the wellbore planning system (353) provides tools for generating reports, exporting data, and documenting drilling plans and decisions. These reports can be shared with regulatory agencies, drilling contractors, and other stakeholders to ensure alignment and compliance throughout the drilling lifecycle.

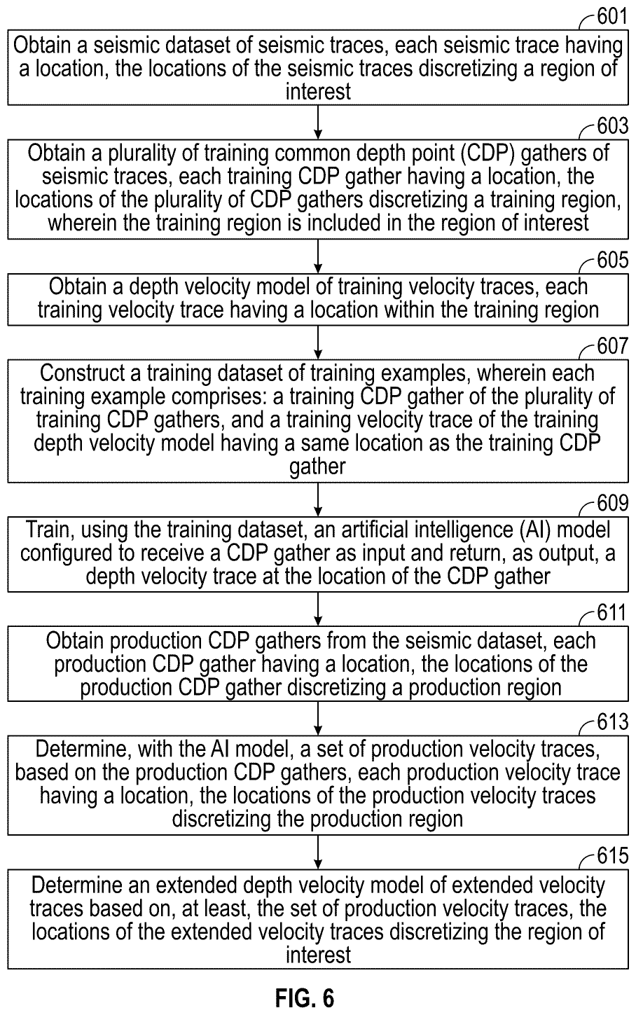

In accordance with one or more embodiments, the flowchart in FIG. 6 depicts a method for determining, using artificial intelligence, an extended depth velocity model in a region of interest, from a depth velocity in a training region included in the region of interest. A seismic dataset of seismic traces is obtained in Step 601. The seismic dataset may be obtained from various origins, including a legacy seismic project or a new seismic acquisition such as the seismic acquisition (1). In other scenarios, the seismic traces may be synthetized.

In Step 603, a plurality of training common depth point (CDP) gathers of seismic traces is obtained, which can be done in the same way as the training CDP gathers (205) are obtained FIG. 2. The locations of the training CDP gathers discretize a training region. In one or more embodiments, the training CDP gathers are obtained by sorting the sorting seismic traces of the seismic dataset from Step 601 in the CMP domain. As mentioned in other parts of this disclosure, the seismic traces may be pre-processed or regularized, or both, prior to being sorted in the CMP domain. In some scenarios, it may be useful to obtain a complete set of CDP gathers, located on a spatial grid that discretizes the whole area of interest, and then define the training CDP gathers as the CDP gathers having a location in the training region. In other embodiments, the training CDP gathers are obtained from a legacy seismic project, that was previously completed in an area that includes the training area. In such scenarios, the training CDP gathers might already be pre-processed and regularized. If not, the seismic traces from the legacy seismic project may be pre-processed or regularized, or both, prior to be sorted in the CMP domain to form the training CDP gathers.

In Step 605, a training depth velocity model of training velocity traces is obtained, as an estimate of the speed of sound in the subsurface below the training region. The training depth velocity model may be obtained in a similar fashion to the training depth velocity model (203) in FIG. 2. The locations of the training velocity traces discretize the training region. In some embodiments, the training depth velocity model is obtained from a legacy seismic project, and possibly interpolated to the locations of the training CDP gathers from Step 603. In other embodiments, no depth velocity model is available for the training region and the training depth velocity model must be computed, for instance, by using one or more of a residual tomography, a full waveform inversion, empirical editions. Each training velocity trace has a location that is assumed to coincide with a location of a CDP from Step 603.

A training dataset is constructed in Step 607, composed of training examples that each include an input and an associated output. An example of such a training dataset is represented by the training dataset (209) in FIG. 2. The input of a training example is a training CDP gather from Step 603, having a location, and the associated output is a training velocity trace from Step 605, having the same location as the input. In Step 609, the training dataset from Step 607 is used to train an artificial intelligence (AI) model configured to receive a CDP gather as input and return, as output, a velocity trace at the same location as the CDP gather. An example of such a model is described as the AI model (211) in FIG. 2 and may include a random forest, a polynomial regression, a neural network (NN), or any combination thereof. Notable examples of neural networks that may be included in the AI model in Step 609 include a deep neural network (DNN), a convolutional neural network (CNN), a recurrent neural network (RNN), a long-short term memory (LSTM) network, or any combination thereof.

In Step 611, production CDP gathers are obtained, with locations discretizing a production region, that includes, at least, the difference between the region of interest (102) and the training region. Thus, the production region may be the whole region of interest, or it may exactly the difference between the region of interest and the training region, or it may include a part of the training region and difference between the region of interest and the training region. The production CDP gathers in Step 611 may be obtained by sorting seismic traces of seismic dataset in the CMP domain. As mentioned in other parts of this disclosure, the seismic traces may be pre-processed or regularized, or both, prior to being sorted in the CMP domain. The production CDP gathers are intended to be used as input to the AI model from Step 609, and therefore, the production CDP gathers may need to be re-formatted, in accordance with some embodiments. Example of re-formatting that may be done to the production CDP gathers include re-sampling the production CDP gathers to a same time sampling rate as the training CDP gathers from Step 603, or adjusting the trace length of the production CDP gathers to the same trace length as the training CDP gathers from Step 603.

In Step 613, a production velocity trace is obtained at each of the production CDP locations from Step 611, using each production CDP gathers from Step 611 as an input to AI model from Step 609. Thus, the locations of the production velocity traces discretize the production region. In Step 615, an extended depth velocity model is determined, composed of velocity traces called extended velocity traces. The extended velocity traces comprise at least the production velocity traces, and the locations of the extended velocity traces discretize the region of interest. In a specific scenario for which the production region is the whole region of interest, the extended depth velocity model is the same as set of the production velocity traces from Step 613. In a specific scenario for which the production region is exactly the difference between the region of interest and the training region, the extended depth velocity model is composed of the production velocity traces and all the training velocity traces from the training depth velocity model (203). In a specific scenario for which the production region comprises a part of the training region, and the difference between the region of interest and the training region, the extended depth velocity model is composed of the production velocity traces from Step 613, and the training velocity traces, from the training depth velocity model (203), that are not located in the production region.

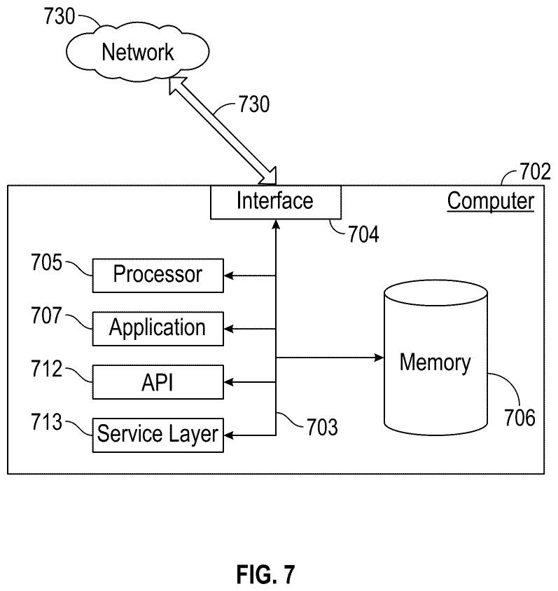

The computations mentioned in this disclosure may be performed by a computer, such as the computer (GGG43) in FIG. GGG. In that regard, FIG. 7 depicts a block diagram of a computer (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. In some implementations, one or more components of the computer (702) may be configured to operate within environments, including cloud-computing-based, local, global, or other environments (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). The memory may be a non-transitory computer readable medium. For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers such as the computer (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers such as the computer (702).

### Examples

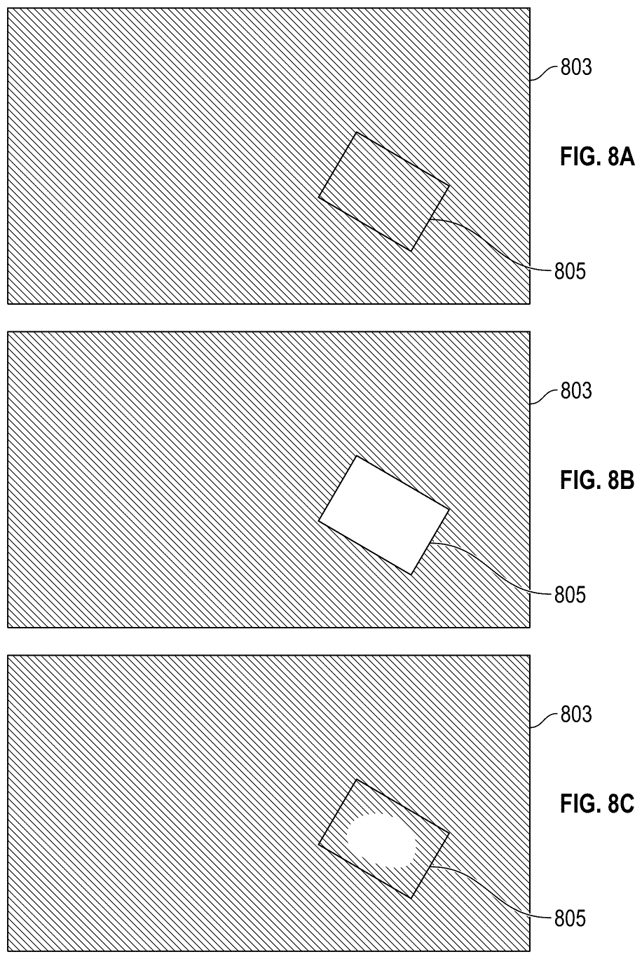

FIGS. 8A-8C depict examples of a training region (805), included in a region of interest (803), that may be used in the method in FIG. 6 or the systems in FIGS. 2 and 3. An AI model, such as the AI model (211), may be trained using CDP gathers with a location discretizing the training region as inputs, such as the training CDP gathers (205), and training velocity traces at the same locations as the training CDP gathers as targets, such as the training velocity traces composing the training depth velocity model (203). Once trained, the AI model may be used to predict velocity traces discretizing a production region, depicted as a dashed region in FIGS. 8A-8C. In FIG. 8A, the production region is the whole region of interest (803). In FIG. 8B, the production region is a difference between the region of interest (803) and the training region (805). In FIG. 8C, the production region includes the difference between the region of interest (803) and the training region (805), and a part of the training region (805).

Table I features examples of synthetic values for the coordinates (xₘ, yₘ, hₓ, h_{y}) of seismic traces 1, 2, . . . , N, where (xₘ, yₘ) are the coordinates of midpoints for each traces, hₓ are x-offset values for each seismic trace, and h_{y} are y-offset values for each seismic trace. Table II features examples of regularized coordinates (xₘ, yₘ, hₓ, h_{y}) of seismic traces 1, 2, . . . , N, from the synthetic values for the coordinates (xₘ, yₘ, hₓ, h_{y}) in Table I. In Table II, the values for the regularized (xₘ, yₘ) are obtained on regular, rectangular spatial bins with a length of 25 m and a width of 25 m. The regularized x-offset values, hr, and y-offset values, h_{y}, are obtained on regular x-offset grid, and a regular y-offset grid, respectively, each grid having a spacing of 100 m between its elements. As synthetic, the values in Table I and Table II are given for illustration purposes and show examples regular bins used in regularizing seismic traces. A CDP gather composed of regular seismic traces is called a regularized CDP gather. The seismic traces within a regularized CDP gather have a same location. The locations of regular CDP gathers are regular, evenly spaced. The x-offset values, hₓ, and y-offset values, h_{y} of regular CDP gathers are evenly spaced. It is further noted that regularized CDP gathers each have the same number of seismic traces, and each regularized CDP gather contains exactly one seismic trace for each (x-offset,y-offset) pair.

TABLE I
Synthetic values for coordinates
(xₘ, yₘ, hₓ, h_{y}) of seismic traces 1, 2 , . . . , N.

| | Xₘ | Yₘ | hₓ | h_{y} |
|---|---|---|---|---|
| Seismic trace 1 | 2230.12 | 3167.99 | 3379.22 | 489.73 |
| Seismic trace 2 | 10065.02 | 2157.78 | 2114.67 | 3210.31 |
| - - - | - - - | - - - | - - - | - - - |
| Seismic trace N | 5705.72 | 3318.65 | 6769.11 | 2333.18 |

TABLE II
(xₘ, yₘ, hₓ, h_{y}): Synthetic values for regularized coordinates of
the (xₘ, yₘ, hₓ, h_{y})seismic traces 1, 2, . . . , N from Table I.

| | Regularized | Regularized | Regularized | Regularized |
|---|---|---|---|---|
| | Xₘ | Yₘ | hₓ | h_{y} |
| Seismic trace 1 | 2225.00 | 3175.00 | 3400.00 | 500.00 |
| Seismic trace 2 | 10075.00 | 2150.00 | 2100.00 | 3200.00 |
| - - - | - - - | - - - | - - - | - - - |
| Seismic trace N | 5700.00 | 3325.00 | 6800.00 | 2300.00 |

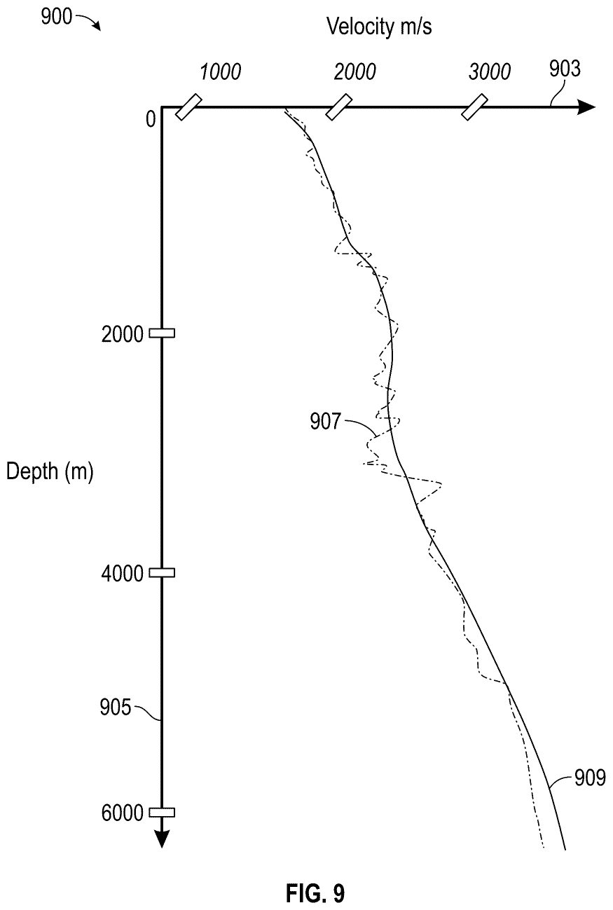

FIG. 9 depicts a graph (900), that includes a first profile (907) of a synthetic depth sonic log and a second profile (909) of a synthetic velocity trace. The abscissa axis (903) represents a velocity, measured in meters per second, and the ordinate axis (905) represents a depth, measured in meters, at a fictitious well location. As performed in the well log analysis in the description of FIG. 3, a velocity mismatch may be computed as a distance between the first profile (907) and the second profile (909), such as, form example, an lₚ-norm of a difference between the first profile (907) and the second profile (909), for some p∈[1, ∞). Then, in some embodiments, a first validation may be defined as positive if the velocity mismatch is less than or equal to a predefined similarity threshold, or negative if the velocity mismatch is greater than the similarity threshold.

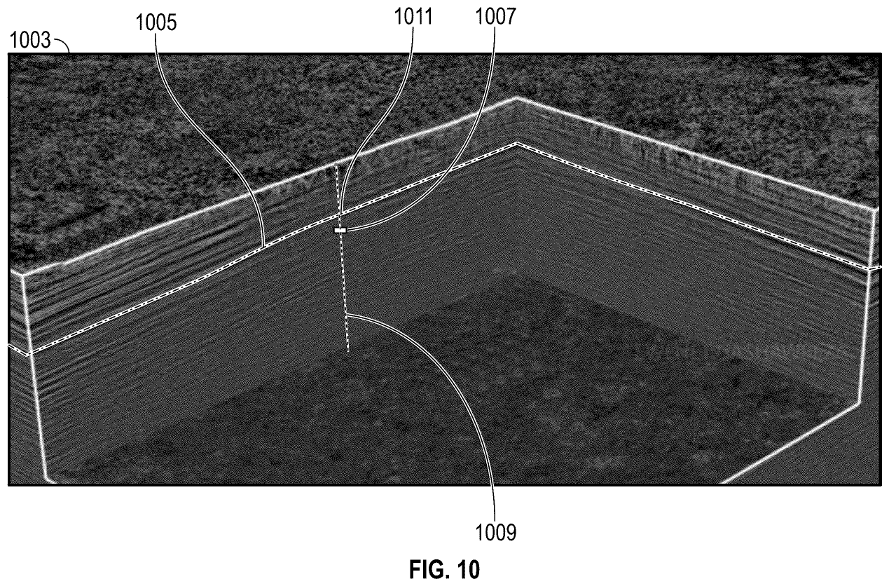

FIG. 10 illustrates an example of a well-tie analysis, similar to the well-tic analysis described in the description of FIG. 3. FIG. 10 includes a three-dimensional view of an example of a depth image (1003) obtained by migrating a seismic dataset with an extended depth velocity model obtained using the system in FIG. 2. A horizon (1005) tracks a geological event on the depth image (1003) and intersects a synthetic well (1009) at point (1011). The synthetic well (1009) includes a well marker (1007) for the geological event that is tracked by the horizon (1005). A well-tie analysis may be performed for the well marker (1007) by computing a depth mismatch between the horizon (1005) and the well marker (1007), the depth mismatch equal to an absolute value of a difference between a depth of the well marker (1007) and a depth of the point (1011). Then, the depth mismatch may be compared against a pre-defined depth matching threshold. Then, the horizon (1005) may be considered as close to the well marker (1007) if the depth mismatch is less than or equal to the depth matching threshold. On another hand, the horizon (1005) may be considered as not close to the well marker (1007) if the depth mismatch is greater than the depth matching threshold.

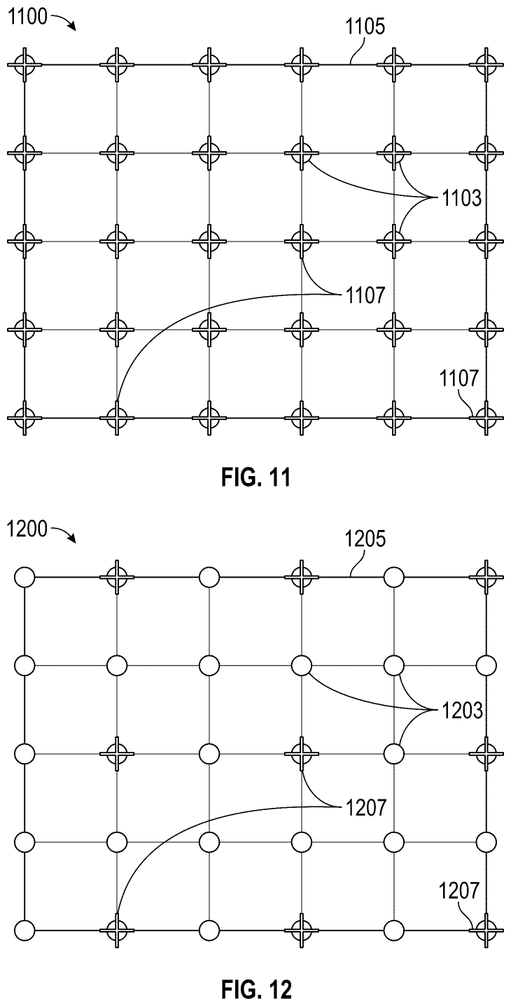

A plot (1100) in FIG. 11 illustrates synthetic examples of locations of some seismic trace of a depth image, such as the depth image (327), the locations represented as dots, such as the dots (1103). The dots (1103) are evenly spaced on a grid (1105) of rectangular bins. The plot (1100) further includes synthetic examples of locations of velocity traces as they might be obtained by the AI model (211), such as the velocity traces of the extended depth velocity model (213) in FIG. 2. The locations of the velocity traces are represented as crosses, such as the crosses (1107). In the specific, synthetic example in FIG. 11, the spatial sampling of the velocity traces is the same as the spatial sampling of the seismic traces of a depth image.

A plot (1200) in FIG. 12 illustrates synthetic examples of locations of some seismic trace of a depth image, such as the depth image (327), the locations represented as dots, such as the dots (1203). The dots (1203) are evenly spaced on a grid (1205) of rectangular bins. The plot (1200) further includes synthetic examples of locations of velocity traces as they might be obtained by the AI model (211), such as the velocity traces of the extended depth velocity model (213) in FIG. 2. The locations of the velocity traces are represented as crosses, such as the crosses (1207). In the specific, synthetic example in FIG. 12, the spatial sampling of the velocity traces is coarser than the spatial sampling of the seismic traces of a depth image, which occurs in some seismic projects.

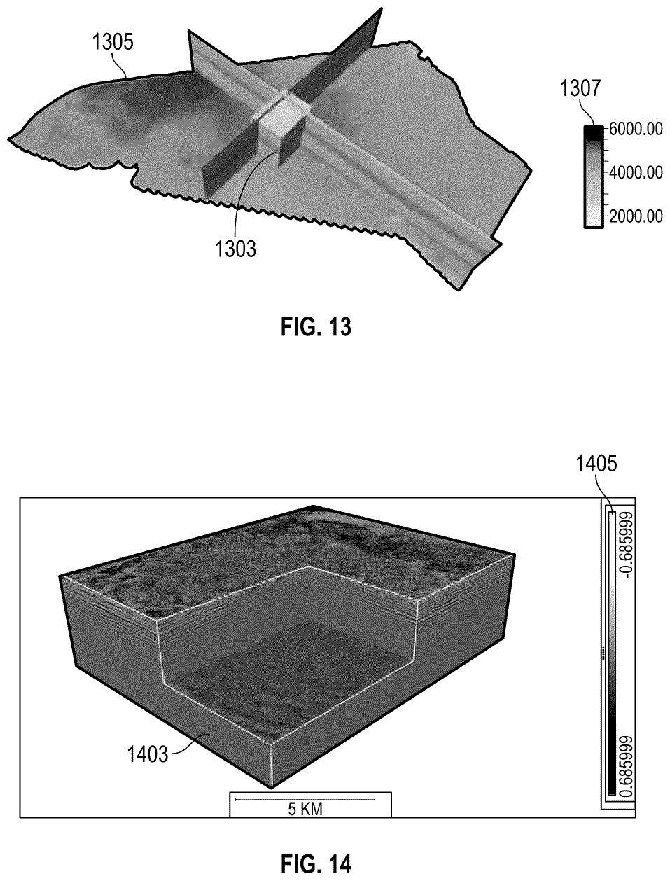

FIG. 13 depicts an example of a training depth velocity model (1303) of training velocity traces in a training region, and an extended depth velocity model (1305) that was obtained using the method in FIG. 6. The traces of the extended depth velocity model (1305) that are located outside the training region were predicted by the AI model in Step (609) of the method in FIG. 6. The values of the velocities are given by the colormap (1307). The extended depth velocity model (1305) may be used, in combination with a migration algorithm, to compute a depth image of the region of interest (102). In one or more embodiments, the extended depth velocity model (1305) may further be used to determine some reservoir properties, such as the reservoir properties (337).

FIG. 14 shows an example of a depth image (1403) obtained by migrating seismic traces of a seismic dataset using the extended depth velocity model from FIG. 13. The values of the seismic amplitudes are given by the colormap (1405). The depth image (1403) may be used by seismic interpreters to perform some interpretation tasks, such as interpreting key geological horizons that delimit stratigraphic layers, boundaries, and structural features of the subsurface (103). In one or more embodiments, results of the interpretation tasks may enable seismic interpreters to locate a potential hydrocarbon reservoir in the subsurface (103), determining some reservoir properties for the potential hydrocarbon reservoir and produce a reservoir map (335) for the potential hydrocarbon reservoir.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining a seismic dataset of seismic traces, each seismic trace having a location, the locations of the seismic traces discretizing a region of interest;
obtaining a plurality of training common depth point (CDP) gathers of seismic traces, each training CDP gather having a location, the locations of the plurality of training CDP gathers discretizing a training region, wherein the training region is included in the region of interest;
obtaining a training depth velocity model of training velocity traces, each training velocity trace having a location within the training region;
constructing a training dataset of training examples, wherein each training example comprises:
a training CDP gather of the plurality of training CDP gathers, and
a training velocity trace of the training depth velocity model having a same location as the training CDP gather;
training, using the training dataset, an artificial intelligence (AI) model configured to receive a CDP gather as input and return, as output, a velocity trace at the location of the CDP gather;
obtaining production CDP gathers from the seismic dataset, each production CDP gather having a location, the locations of the production CDP gathers discretizing a production region;
determining, with the AI model, a set of production velocity traces, based on the production CDP gathers, each production velocity trace having a location, the locations of the production velocity traces discretizing the production region; and
determining an extended depth velocity model of extended velocity traces based on, at least, the set of production velocity traces, the locations of the extended velocity traces discretizing the region of interest.

2. The method of claim 1, wherein:
the production region is a difference between the region of interest and the training region; and
the extended depth velocity model comprises the training velocity traces.

3. The method of claim 1, wherein the AI model comprises a neural network.

4. The method of claim 1, further comprising post processing the extended depth velocity model, wherein post-processing the extended depth velocity model comprises smoothing the extended depth velocity model.

5. The method of claim 1, wherein obtaining the training velocity traces comprises running one or more algorithms selected from the group consisting of a residual moveout tomography and a full waveform inversion.

6. The method of claim 1, further comprising pre-processing the training CDP gathers and the production CDP gathers, according to a set of pre-processing parameters.

7. The method of claim 1 further comprising:
obtaining a depth sonic log at a well location in the region of interest;
determining a modeled depth velocity trace from the extended depth velocity model at the well location;
computing a velocity mismatch between the depth sonic log and the modeled depth velocity trace;
obtaining a similarity threshold;
making a first determination of whether the velocity mismatch is less than the velocity matching threshold, and
upon determining that the velocity mismatch is less than the similarity threshold, computing a depth image from the seismic dataset and the extended depth velocity model, a lateral extent of the depth image covering the region of interest.

8. The method of claim 1 further comprising obtaining a depth image from the seismic dataset and the extended depth velocity model, a lateral extent of the depth image covering the region of interest.

9. The method of claim 8, further comprising:
obtaining a depth marker for a geological event at a well location;
determining, from the depth image, a depth horizon at the well location for the geological event;
computing a depth mismatch between the depth marker and the depth horizon;
obtaining a depth matching threshold;
making a second determination of whether the depth mismatch is less than the depth matching threshold; and
upon determining that the depth mismatch is less than the depth matching threshold, localizing a hydrocarbon reservoir within a subsurface below the region of interest using, at least in part, the depth image.

10. The method of claim 8, further comprising:
localizing a hydrocarbon reservoir within a subsurface below the region of interest using, at least in part, the depth image;
determining, based on the depth image and the extended depth velocity model, one or more reservoir properties for the hydrocarbon reservoir;
making a decision, based on the one or more reservoir properties, of drilling a hydrocarbon well perforating the hydrocarbon reservoir;
planning a wellbore path that penetrates the hydrocarbon reservoir; and
drilling a wellbore guided by the planned wellbore path.

11. A system, comprising:
a seismic acquisition system configured to acquire a seismic dataset of seismic traces, each seismic trace having a location, the locations of the seismic traces discretizing a region of interest; and
a seismic processing system configured to:
receive the seismic dataset from the seismic acquisition system;
form using the seismic dataset, or receive, a plurality of training common depth point (CDP) gathers of seismic traces, each training CDP gather having a location, the locations of the plurality of training CDP gathers discretizing a training region, wherein the training region is included in the region of interest;
receive, or compute a training depth velocity model of training velocity traces, each training velocity trace having a location within the training region;
construct a training dataset of training examples, wherein each training example comprises:
a training CDP gather of the plurality of training CDP gathers, and
a training velocity trace of the training depth velocity model having a same location as the training CDP gather;
train, using the training dataset, an artificial intelligence (AI) model configured to receive a CDP gather as input and return, as output, a velocity trace at the location of the CDP gather;
form production CDP gathers from the seismic dataset, each production CDP gather having a location, the locations of the production CDP gathers discretizing a production region;
determine, by using the AI model with each production CDP gather as input, a set of production velocity traces, based on the production CDP gathers, each production velocity trace having a location, the locations of the production velocity traces discretizing the production region; and
determine an extended depth velocity model of extended velocity traces based on, at least, the set of production velocity traces, the locations of the extended velocity traces discretizing the region of interest.

12. The system of claim 11, wherein:
the production region is a difference between the region of interest and the training region; and
the extended depth velocity model comprises the training velocity traces.

13. The system of claim 11, wherein the AI model comprises a neural network.

14. The system of claim 11, wherein the seismic processing system is further configured to comprising post process the extended depth velocity model, wherein post-processing the extended depth velocity model comprises smoothing the extended depth velocity model.

15. The system of claim 11, wherein computing the training velocity traces comprises running one or more algorithms selected from the group consisting of a residual moveout tomography and a full waveform inversion.

16. The system of claim 11, wherein the seismic processing system is further configured to pre-process the training CDP gathers and the production CDP gathers, according to a set of pre-processing parameters.

17. The system of claim 11, wherein the seismic processing system is further configured to:
receive a depth sonic log at a well location in the region of interest;
determine a modeled depth velocity trace from the extended depth velocity model at the well location;
compute a velocity mismatch between the depth sonic log and the modeled depth velocity trace;
make a first determination of whether the velocity mismatch is less than the velocity matching threshold; and
upon determining that the velocity mismatch is less than the similarity threshold, compute a depth image from the seismic dataset and the extended depth velocity model, a lateral extent of the depth image covering the region of interest.

18. The system of claim 11, wherein the seismic processing system is further configured to compute a depth image from the seismic dataset and the extended depth velocity model, a lateral extent of the depth image covering the region of interest.

19. The system of claim 18, wherein the seismic processing system is further configured to:
receive a depth marker for a geological event at a well location;
determine, from the depth image, a depth horizon at the well location for the geological event;
compute a depth mismatch between the depth marker and the depth horizon;
receive a depth matching threshold;
make a second determination of whether the depth mismatch is less than the depth matching threshold; and
upon determining that the depth mismatch is less than the depth matching threshold, localize a hydrocarbon reservoir within a subsurface below the region of interest using, at least in part, the depth image.

20. The system of claim 18, further comprising:
a seismic interpretation system configured to:
localize a hydrocarbon reservoir within a subsurface below the region of interest using, at least in part, the depth image,
determine, based on the depth image and the extended depth velocity model, one or more reservoir properties for the hydrocarbon reservoir, and
make a decision, based on the one or more reservoir properties, of drilling a hydrocarbon well perforating the hydrocarbon reservoir;
a wellbore planning system configured to plan a wellbore path that penetrates the hydrocarbon reservoir; and
a drilling system configured to drill a wellbore guided by the planned wellbore path.
